(19) United States
(12) Patent Application Publication
(10) Pub. No.: US 2014/0360623 A1
(43) Pub. Date: Dec. 11, 2014

(54) Medical Device Having Integrated Sequence Control

(71) Applicant: Novo Nordisk Healthcare AG, Zurich (CH)

(72) Inventors: Christian H. Nielsen, Copenhagen NV (DK); Josefine Carlsson, Kavling (SE); Klaus Bendix, Vanloese (DK); Lars Eilertsen, Fredensborg (DK); Matias Melander, Copenhagen (DK)

(21) Appl. No.: 14/363,407

(22) PCT Filed: Dec. 6, 2012
(86) PCT No.: PCT/EP2012/074596

§ 371 Date: Jun. 6, 2014

Related U.S. Application Data
(60) Provisional application No. 61/569,831, filed on Dec. 13, 2011.

(30) Foreign Application Priority Data
Dec. 8, 2011 (EP) 11192613.5

(51) Int. Cl. A61J 1/20

(52) U.S. Cl. CPC A61J 1/2096; A61J 2001/201; A61J 2001/2065
USPC 141/27

(57) ABSTRACT

The present invention relates to a medical device comprising a base member (2), a container (20) comprising a container interior (28) adapted to accommodate a substance, and a container closure (23) for fluidly sealing the container interior, and fluid connection means (50) for establishing fluid connection to the container interior. A cover (4) removably mountable on a cover receiving portion (36) is operatively coupled with the fluid connection means (50) to cause a relative motion between the fluid connection means (50) and the container closure (23) in response to a relative motion between the cover (4) and the base member (2). The medical device further comprises a cover engagement mechanism (9, 37, 46, 49) configured to prevent movement of the cover in a dismounting direction relative to the cover receiving portion when the cover and the base member are in a first relative position in which the fluid connection means (50) and the container interior (28) are fluidly separated and to allow movement of the cover (4) in a dismounting direction relative to the cover receiving portion (36) when the cover and the base member are in a second relative position in which the fluid connection means and the container interior are fluidly connected.

### FIELD OF THE INVENTION

The present invention relates to fluid transfer devices, particularly to medical mixing devices.

### BACKGROUND OF THE INVENTION

Within drug delivery it may be of vital importance to maintain sterility of a product to be administered from its production to its administration. Many drug substances are therefore supplied in sealed containers having penetrable access means, such as rubber septa, which are adapted to be pierced by a suitable tool, e.g. a hollow needle.

For example, people with IDDM frequently attach an injection needle to their insulin pen to thereby penetrate a self-sealing rubber septum of an insulin containing cartridge and establish a delivery line for subcutaneous administration. The needle and the insulin are stored in respective sterile environments until the point of connection.

Some pharmaceutical drugs adapted for parenteral administration are only stable in the administrable form a relatively short period of time. For convenience reasons, and in order to extend the shelf life of such a drug, it is sometimes preferred to store individual constituents of the drug separately and to mix them only just before a dose is needed.

Traditionally, a mixing of two substances stored in separate vials is performed using a syringe with a needle to withdraw the substance from the one vial and inject it into the other vial. The syringe with the attached needle is then used to withdraw from this vial the desired amount of drug to be injected into the patient. This kind of manual operation may be difficult and may bring about some uncertainty as to the exact concentration of the resulting drug, because it can be difficult to completely empty a vial by such an approach. Moreover, since the first substance is withdrawn from one vial and transported to another vial via a syringe with a needle, typically including a penetration of two rubber septa in order to establish fluid connection to the respective vial interiors, both sterility and safety may be compromised. To reduce the risk of contamination of the administrable substance it is customary to clean the respective rubber septa with an alcohol swab before needle penetration. This, however, is often considered a hassle by the user, especially if she/he needs to mix the substances and administer the resulting drug quickly to avert a serious situation.

U.S. Pat. No. 5,466,220 (Bioject, Inc.) discloses different examples of drug vial mixing and transfer devices comprising one or two vials and a syringe pre-aligned and packaged in sealed sterile packages to eliminate the need for swabbing the vials before piercing and to avoid sharp needle exposures. While overcoming some of the drawbacks of the traditional way of mixing substances, the solutions comprising two vials appear bulky and operationally cumbersome, and the solutions including a single vial introduce a risk of carrying out the individual operational steps in a wrong order, because the syringe plunger is operable before connection of the vial and the syringe, thereby enabling a delivery of some of the syringe contents to the exterior of the vial.

WO 97/46203 (Applied Research Systems ARS Holding N.V.) discloses a pre-assembled pack for a drug reconstituting device, which pack comprises a vial co-axially aligned with a cartridge and separated therefrom by a double-ended needle element. In the pre-use state of the device the needle element is shielded at each end by a slidable bung, providing for closed, sterile needle chambers. Like the above mentioned prior art solutions including a single vial, this pack also lacks a mechanism which prevents it from being manipulated erroneously to e.g. expel the contents of the cartridge before fluid connection to the vial has been established.

### SUMMARY OF THE INVENTION

It is an object of the invention to provide a solution which eliminates, or at least reduces, drawbacks of the prior art.

In particular, it is an object of the invention to provide a medical device which is simple to operate and which offers an automatic sequence control guaranteeing a correct sequence of at least some key operations of the device.

It is a further object of the invention to provide a fluid transfer device offering safe and sterile establishment of fluid connection to a substance container.

It is an even further object of the invention to provide a medical mixing device comprising a user operable actuation mechanism which cannot be operated until fluid communication is properly established between respective substance containing reservoirs.

In the disclosure of the present invention, aspects and embodiments will be described which will address one or more of the above objects and/or which will address objects apparent from the below disclosure as well as from the description of exemplary embodiments.

In a first aspect of the invention a medical device is provided comprising a base member, a first container comprising a first container interior adapted to accommodate a first substance, and a first container closure for fluidly sealing the first container interior, and a second container comprising a second container interior adapted to accommodate a second substance, and a second container closure for fluidly sealing the second container interior. The medical device further comprises fluid connection means for establishing fluid communication between the first container interior and the second container interior, and fluid transfer means for causing transfer of the first substance to the second container interior. A cover is removably mounted on a cover receiving portion to shield at least a portion of the fluid transfer means and is operatively coupled with the fluid connection means to cause a relative motion between the fluid connection means and at least one of the first container closure and the second container closure in response to a relative motion between the cover and the base member. An incorporated cover engagement mechanism is configured to prevent movement of the cover in a dismounting direction relative to the cover receiving portion when the cover and the base member are in a first relative position, in which the first container interior and the second container interior are fluidly unconnected, and to allow movement of the cover in a dismounting direction relative to the cover receiving portion when the cover and the base member are in a second relative position in which fluid communication is established between the first container interior and the second container interior.

Such a construction enables the provision of a medical device capable of transferring a substance from one container to another, which device may be operated by a user to execute the transfer only after removal of a protective cover and proper establishment of fluid communication between the respective container interiors. Thereby, it is ensured that a premature fluid transfer cannot take place and, consequently, that no substance wastage can occur. This is particularly relevant when a specific volumetric ratio of the first substance and the second substance is needed to produce a predictable medical treatment outcome. It is further relevant in order to avoid leakage within the device potentially causing damage to the internal components as well as giving rise to a perception of the product being unreliable. The construction further provides a medical mixing device which offers separate storage of the individual substances to be mixed and simple, easy and safe establishment of a fluid pathway between the substances, requiring a minimum number of manual operational steps.

In the present context, “movement of the cover in a dismounting direction relative to the cover receiving portion” means a movement of the cover in a direction that will eventually lead to a dismounting from the cover receiving portion. Such movement may include a translation, e.g. along an axis defined by the cover receiving portion, a rotation, e.g. about an axis defined by the cover receiving portion, or a spiraling movement of the cover relative to the cover receiving portion.

The first container may be a fixed volume reservoir or a variable volume reservoir capable of selective decrease and/or increase of an internal volume. A suitable variable volume reservoir may e.g. comprise a user operable actuator operatively coupled with a movable wall, one example of such a reservoir being a syringe which comprises a movable piston adapted for actuation by a user operable piston rod. In that case the cover may be adapted to shield the actuator when mounted on the cover receiving portion. Similarly, the second container may have a fixed or variable internal volume.

In particular embodiments the first container and the second container are co-axially arranged along a general axis, and the fluid connection means is arranged at least partially between the first container and the second container. Thereby, an attractive slender configuration of the medical device may be provided which makes it suitable for being carried about in e.g. a pocket or a handbag.

The fluid connection means may comprise a central portion carrying one or more pointed hollow shaft members, such as one or more needles or spikes. In particular, the central portion may carry either a single needle/spike or two oppositely pointing, fluidly connected, needles/spikes. The central portion may be encircled by a cylindrical sleeve extending substantially parallel to the one or more hollow shaft members.

The fluid transfer means may comprise an initial pressure difference between the first container interior and the second container interior or, alternatively, an actuation mechanism for selectively establishing a pressure difference between the two container interiors. The actuation mechanism may e.g. be adapted to selectively create an excess pressure in the first container or a negative pressure in the second container for transferring the first substance from the first container to the second container. The actuation mechanism may further be adapted to selectively create an excess pressure in the second container or a negative pressure in the first container for transferring a mixture of the first substance and the second substance from the second container to the first container.

The actuation mechanism may be arranged in connection with either the first container or the second container, such as e.g. in the form of a piston rod in a syringe, or it may be arranged separately from the two containers.

The base member may e.g. comprise a holder, protector and/or a support for one of the containers. For example, in case the container is of the fixed volume reservoir type, such as e.g. a vial, the base member may be a protective cover for the reservoir. In case the container is of the variable volume reservoir type, such as e.g. a cartridge, the base member may be a reservoir holder. Alternatively, or additionally, the base member may be a housing or a part of a housing for internal components of the medical device, or it may simply be a component with respect to which the container is translationally or rotationally fixed.

The operative coupling between the cover and the fluid connection means may comprise a mechanical coupling between the cover and one of the first container and the second container and a mechanical coupling between the container in question and the fluid connection means. Specifically, the cover may mechanically interface, e.g. by engagement or abutment, a portion of the first container which is immovable relative to a first container outlet. Thereby, it is ensured that the pressure in the first container interior remains fixed when the first container is moved, regardless of which type of container is employed.

The mechanical interaction between the cover and the first container may be realised via coupling means, such as protrusions, on the inner surface of the cover structured to interface with a radially outwardly extending flange portion on or associated with the first container to enable joint motion of the cover and the first container in a first direction.

In some embodiments, the cover and the first container are coupled to enable joint translational motion of the two in a first direction along the general axis.

The relative motion between the cover and the base member that induces a relative motion between the fluid connection means and at least one of the first container closure and the second container closure may be purely translational, purely rotational or helical. In some embodiments the relative motion between the cover and the base member comprises a converging translational relative motion.

The cover engagement mechanism may comprise a releasable interlocking of the cover and the cover receiving portion, e.g. realised via a position dependable interaction between respective portions of the cover, the cover receiving portion, and a wall extending along the general axis.

The cover receiving portion may form part of a first container support member, e.g. a first container holder, and the wall may form part of a second container support member, e.g. a second container holder. Such a construction may minimise the number of different components required for the cover engagement mechanism and may thereby reduce the manufacturing costs and the complexity of the medical device. The wall may alternatively, or additionally, form part of a sleeve member which is structured to accommodate at least a portion of the fluid connection means and to allow axial movement of the fluid connection means in its interior. Such a construction may enable a non-bulky design of the medical device.

The cover engagement mechanism may specifically comprise a radially deflectable portion of the cover receiving portion arranged in releasable engagement with the cover. This radially deflectable portion of the cover receiving portion may be biased radially outwardly relative to the general axis but configured to deflect inwardly when subjected to a radially inwards directed force. The radially deflectable portion may comprise an inclined surface for interaction with an inclined surface, e.g. an inclined inner surface or opening, of the cover to generate a radial force component for action on the radially deflectable portion when an axial pull force is applied to the cover.

The cover engagement mechanism may be structured such that radial inwards deflection of the radially deflectable portion is prevented when the cover and the base member are in the first relative position or between the first relative position and the second relative position and allowed when the cover and the base member are in the second relative position. This may e.g. be accomplished by initially arranging the cover, the cover receiving portion and the wall such that the radially deflectable portion is wedged between the cover and the wall until the cover and the base member are brought to the second relative position. The wall may be provided with an axially extending opening arranged to allow projection therethrough of the radially deflectable portion when the cover and the base member are in the second relative position.

To establish proper fluid communication between the first container interior and the second container interior a relative translational motion of magnitude x₁ between the first container closure and the fluid connection means and a relative translational motion of magnitude x₂ between the second container closure and the fluid connection means are required. The cover engagement mechanism is designed to enable a release of the cover only when the cover and the base member have undergone relative motion to effectively cause a relative translational motion of magnitude x₁ between the first container closure and the fluid connection means and a relative translational motion of magnitude x₂ between the second container closure and the fluid connection. Thereby, it is ensured that the cover cannot be dismounted from the cover receiving portion when e.g. fluid connection has been established to only one of the containers. In particular embodiments, the cover engagement mechanism is designed to enable a release of the cover only when the cover and the base member have undergone a relative converging translational motion of at least a magnitude xᵣ=x₁+x₂.

A portion, e.g. a tip portion, of the radially deflectable portion may be adapted for sliding abutment with the wall during movement of the cover and the base member from the first relative position to the second relative position.

In some embodiments the first container is a variable volume reservoir, e.g. a syringe, releasably fixed to a reservoir holder such that upon transfer of the first substance from the first container to the second container and subsequent transfer of a mixture of the first substance and the second substance from the second container to the first container, the first container may be removed from the reservoir holder and used with suitable delivery means, such as a cannula or an infusion set, for application of the mixed product to a desired site of administration.

The medical device may further comprise a blocking element movable with respect to the base member from a first position in which relative motion between the cover and the base member from the first relative position to the second relative position is prevented to a second position in which relative motion between the cover and the base member from the first relative position to the second relative position is allowed. The first position may be a first translational or rotational position of the blocking element relative to the base member and the second position may be a second translational or rotational position of the blocking element relative to the base member. For example, in the second position the blocking element may be completely removed from the medical device.

The blocking element may, when positioned in the first position, prevent axially converging relative motion between the cover and the base member, in which case the blocking element may act as a spacer element separating the cover from the base member.

The blocking element may comprise a radially inwardly extending flange for supporting the fluid connection means in a pre-use state of the medical device. This will assist in defining and maintaining a correct pre-use positioning of the fluid connection means relative to the respective container closures, thereby ensuring that none of the container closures are prematurely penetrated. The blocking element may further comprise a dedicated interface for user operation to enable an easy switch from the first position to the second position. The dedicated interface may e.g. comprise a pull ring for tearing away the blocking element.

In a second aspect of the invention a medical device is provided comprising a base member, a container comprising a container interior adapted to accommodate a substance, and a container closure for fluidly sealing the container interior, and fluid connection means for establishing fluid connection to the container interior. A cover removably mountable on a cover receiving portion is operatively coupled with the fluid connection means to cause a relative motion between the fluid connection means and the container closure in response to a relative motion between the cover and the base member. The medical device further comprises a cover engagement mechanism configured to prevent movement of the cover in a dismounting direction relative to the cover receiving portion when the cover and the base member are in a first relative position in which the fluid connection means and the container interior are fluidly separated and to allow movement of the cover in a dismounting direction relative to the cover receiving portion when the cover and the base member are in a second relative position in which the fluid connection means and the container interior are fluidly connected.

The fluid connection means may e.g. comprise a hollow needle or spike element having either one or two pointed end portions.

In some embodiments, the medical device is a fluid transfer device comprising a) a vial comprising a substance in a vial interior and a fluid tight vial seal, b) a vial holder to which the vial is firmly attached, c) fluid connection means capable of undergoing relative motion with respect to the vial seal from a first position in which the fluid connection means and the vial interior are fluidly unconnected to a second position in which the fluid connection means and the vial interior are fluidly connected, d) a cover for shielding at least a portion of the fluid connection means, the cover being operatively coupled with the fluid connection means to cause a relative motion between the fluid connection means and the vial seal in response to a relative motion between the cover and the vial holder, e) a cover receiving portion structured for engagement or abutment with the cover when the cover is mounted to shield the at least a portion of the fluid connection means, and f) a cover engagement mechanism structured to prevent movement of the cover in a dismounting direction relative to the cover receiving portion when the cover and the vial holder are in a first relative position and to allow movement of the cover in a dismounting direction relative to the cover receiving portion when the cover and the vial holder are in a second relative position. The fluid connection means comprises a hollow shaft capable of entering the vial interior and attachment means fluidly connected to the hollow shaft, the attachment means being structured to receive an outlet portion of a variable volume reservoir.

In a third aspect of the invention a drug delivery device is provided comprising a) a variable volume drug reservoir, e.g. a cartridge, capable of holding a drug substance in a reservoir interior sealed by a penetrable septum, b) a support member configured to encircle at least a portion of the reservoir, c) an actuator mechanism for altering the volume of the reservoir interior, the actuator mechanism being arranged at least partially in a housing, d) a needle assembly comprising a needle hub carrying a double-pointed needle cannula and attachment means for attaching the needle hub to the reservoir or the support member, e) a removable cap adapted to cover at least a portion of the reservoir, the cap being operatively coupled with the needle assembly to cause a relative motion between the needle assembly and the penetrable septum in response to a relative motion between the cap and the reservoir, f) a cap receiving portion structured for engagement or abutment with the cap when the cap is mounted to cover the at least a portion of the reservoir, and g) a cap engagement mechanism configured to prevent movement of the cap in a dismounting direction relative to the cover receiving portion when the cap and the reservoir are in a first relative position, in which the needle cannula and the reservoir interior are fluidly separated, and to allow movement of the cap in a dismounting direction relative to the cap receiving portion when the cap and the reservoir are in a second relative position in which the needle cannula and the reservoir interior are fluidly connected.

The drug delivery device may further comprise a blocking element, or spacer element, which must be removed to allow relative converging motion of the cover and the housing. The blocking element may thus serve both as a safety against unintended penetration of the reservoir septum by the needle cannula and as a tamper indicator.

In the present specification, reference to a certain aspect or a certain embodiment (e.g. “an aspect”, “a first aspect”, “one embodiment”, “an exemplary embodiment”, or the like) signifies that a particular feature, structure, or characteristic described in connection with the respective aspect or embodiment is included in, or inherent of, at least that one aspect or embodiment of the invention, but not necessarily in/of all aspects or embodiments of the invention. It is emphasized, however, that any combination of features, structures and/or characteristics described in relation to the invention is encompassed by the invention unless expressly stated herein or clearly contradicted by context.

The use of any and all examples, or exemplary language (e.g., such as, etc.), in the text is intended to merely illuminate the invention and does not pose a limitation on the scope of the same, unless otherwise claimed. Further, no language or wording in the specification should be construed as indicating any non-claimed element as essential to the practice of the invention.

### BRIEF DESCRIPTION OF THE DRAWINGS

In the following the invention will be further described with references to the drawings, wherein

FIG. 1 shows an exploded view of a medical device according to an embodiment of the invention,

FIG. 2 shows a longitudinal section view of the device of FIG. 1, in a pre-use state,

FIG. 3 shows a close-up longitudinal section view of the device, in an initial use state, detailing the cover engagement mechanism and the fluid connection means,

FIGS. 4a and 4b show close-up longitudinal section views of the device in different use states,

FIG. 5 shows a close-up longitudinal section view of the device after fluid communication has been established between the container interiors, and

FIG. 6 shows a close-up longitudinal section view of the device after removal of the outer cover.

In the figures like structures are mainly identified by like reference numerals.

### DESCRIPTION OF EXEMPLARY EMBODIMENTS

When in the following relative expressions, such as “upwards” and “downwards”, are used, these refer to the appended figures and not necessarily to an actual situation of use. The shown figures are schematic representations for which reason the configuration of the different structures as well as their relative dimensions are intended to serve illustrative purposes only.

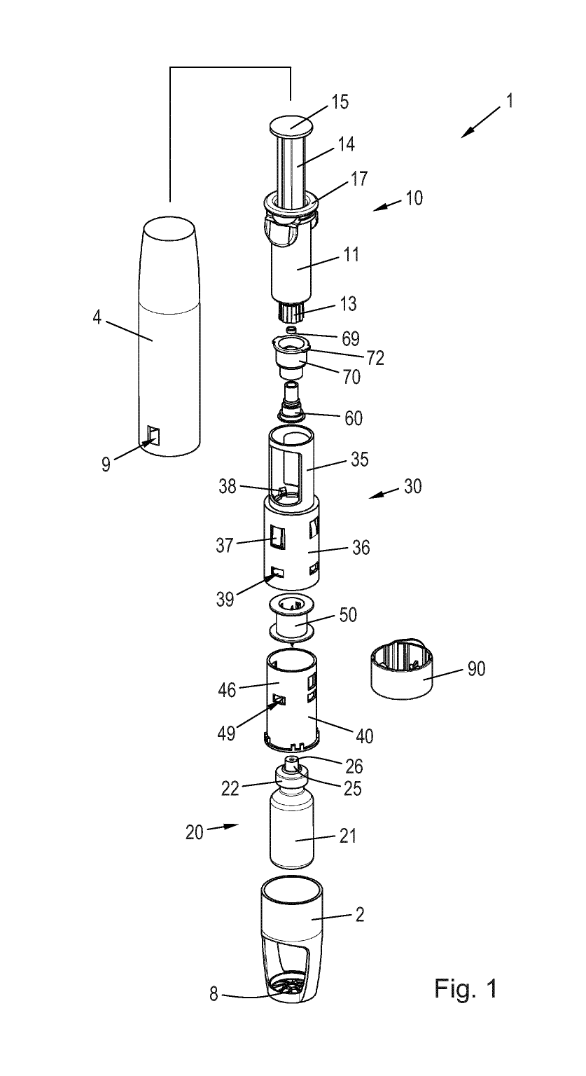

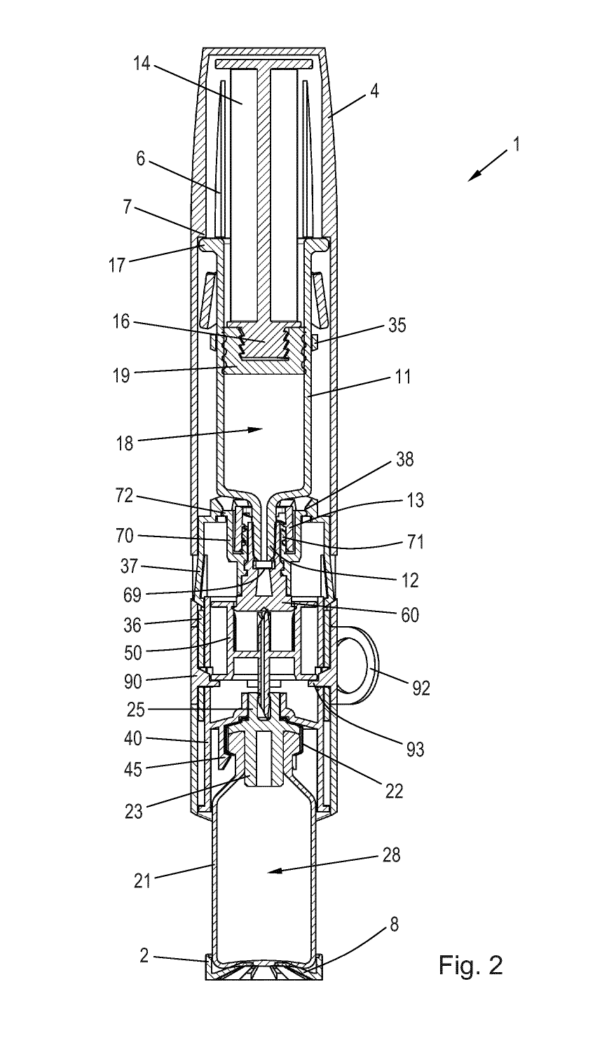

FIG. 1 is an exploded perspective view of a mixing device 1 for reconstitution of a powdered drug in a vial 20 using a solvent from a syringe 10. The vial 20 comprises a wall 21 having an opening which is sealed by a vial stopper 23 (see FIG. 2) and a seal cap 22. A tower 25 protrudes axially from the seal cap 22 in the direction away from the vial 20. The tower 25 has an inner circumferential sealing rim 26 at its end portion, the purpose of which is explained below.

The vial 20 is arranged in a vial protector 2 which serves to protect the vial 20. In the disclosed embodiment the wall 21 is made of glass and the vial protector 2 is made of plastic. Other suitable materials may, however, be chosen, depending on the specific application of the mixing arrangement 1.

The proximal portion of the vial protector 2 has an enlarged diameter to accommodate a distal portion of a sleeve member 40. The sleeve member 40 comprises an axially extending wall 46 and an opening 49 in the wall 46, the opening 49 being arranged to allow release of a cap 4 from the mixing device 1 in a manner which is described in detail below. In this particular embodiment the sleeve member 40 is arranged non-translationally relative to the vial protector 2.

The sleeve member 40 is designed to accommodate a connector piece 50 and to interact with a distal portion of a syringe holder 30. The syringe holder 30 comprises a proximal supporting frame 35 adapted to receive and hold a portion of the syringe 10 and a distal cap receiving portion 36 in the form of a tubular segment provided with a number of circumferentially spaced apart flexible arms 37 as well as a number of openings 39. In the transition between the supporting frame 35 and the cap receiving portion 36 a number of lock snaps 38 are circumferentially distributed. The lock snaps 38 are adapted to fix a stopper fastener 70 to the syringe holder 30 by interaction with a pair of protrusions 72. The stopper fastener 70 holds a syringe stopper 60 in place so as to sealingly close an outlet of the syringe 10. The syringe 10 is of the Luer-Lok type having a threaded Luer collar 13 at the distal end of a barrel 11. A filter 69 is optionally arranged in the syringe stopper 60 to filter out any impurities of a passing liquid. The proximal end portion of the barrel 11 is shaped to provide a circumferential collar 17 having a slightly greater outer diameter than the barrel 11 itself. A piston rod 14 extends from the interior of the barrel 11 and has a proximal push face 15 for operation by a user. The cap 4, which is non-deformable in ordinary use conditions and which is adapted to fit over the syringe 10 and be received by the cap receiving portion 36, is provided with a number of circumferentially spaced apart openings 9 at its distal end portion.

FIG. 1 also shows a spacer element 90 adapted for initial pre-use arrangement between the cap 4 and the vial protector 2 to ensure that an axial spacing between the two is maintained. The spacer element 90 is a bendable, or segmented, band which can be removed by performing a peeling action.

FIG. 2 is a longitudinal section view of the mixing device 1 in the assembled state, prior to a first use thereof, showing further details of the arrangement. This state corresponds to the one in which the mixing device 1 is intended to be delivered by the manufacturer. The piston rod 14 is in a retracted position in the barrel 11, thereby defining a syringe interior 18 capable of holding a certain volume of a solvent (not shown). The piston rod 14 is coupled firmly to a piston 19 via a jagged coupling head 16. The cap 4 is fitted snugly around the collar 17, providing a user friendly slender configuration of the mixing device 1.

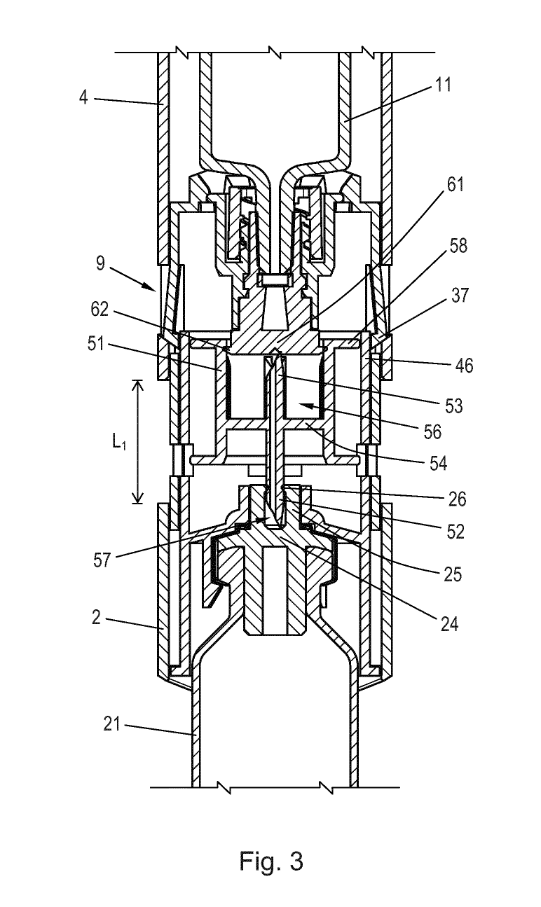

A Luer 12, defining the outlet of the syringe 10, protrudes into the hollow interior of the cap receiving portion 36 and is retained therein via a screw thread connection between the Luer collar 13 and a threaded inner portion 71 of the stopper fastener 70. A portion of the syringe stopper 60 is wedged between the Luer 12 and the threaded inner portion 71 and thereby provides a fluid tight engagement with the exterior surface of the Luer 12. The syringe stopper 60 has a penetrable section 61 (see FIG. 3) allowing for easy rupturing of the syringe sealing by a suitable tool.

The connector piece 50 is slidably received in the hollow interior of the sleeve member 40 and is axially supported by an interior flange 93 on the spacer element 90, the flange 93 defining an exact initial position of the connector piece 50 relative to the penetrable section 61 and a penetrable section 24 (see FIG. 3) of the vial stopper 23. The sleeve member 40 has a number of circumferentially spaced apart catch arms 45 extending downwards from a transversal interior portion for securing firm attachment of the vial 20. The wall 21 defines a vial interior 28 capable of holding an amount of powdered drug (not shown) to be reconstituted by the solvent from the syringe 10. The wall 21 is flexibly supported by leaf springs 8 in the bottom of the vial protector 2 to account for manufacturing tolerances.

In FIG. 2 the cap 4 is mounted on the cap receiving portion 36 whereby the entire syringe 10 is shielded from the surroundings. A number of ribs 6 extend axially along an inner portion of the cap 4, each of the ribs 6 having a distally oriented contact face 7 adapted for interaction with the collar 17. The respective flexible arms 37 are biased such that they flex into the respective openings 9 in the cap 4. Each flexible arm 37 is provided with an inclined surface which interacts with an inclined surface of the corresponding opening 9 such that an axial proximally directed force applied to the cap 4 will result in a radially inwards directed force on the flexible arms 37. In this pre-use state of the mixing device 1 the flexible arms 37 abut the sleeve member 40 and are prevented from inwards deflection by the wall 46. Thereby, the cap 4 is prevented from being dismounted from the cap receiving portion 36. It is noted that in the shown embodiment the openings 9 are cut-outs in the cap 4. This, however, need not be the case, as the cap 4 could alternatively be provided with e.g. grooves in inner wall portions. To start using the mixing device 1 the user must first remove the spacer element 90 by pulling a pull ring 92 tangentially.

FIG. 3 is a close-up longitudinal section view of a central portion of the mixing device 1 in a pre-connection state where the spacer element 90 has just been removed. In this state the distal end face of the cap 4 and the proximal end face of the vial protector 2 are axially spaced apart a distance, L₁. The figure details the connector piece 50 and its initial arrangement with respect to the syringe 10 and the vial 20. The connector piece 50 comprises a cylindrical sleeve body 51 with radially outwardly projecting flanges 58 at each end, serving to stabilise the connector piece 50 in the interior of the sleeve member 40. The sleeve body 51 supports a transverse spike base 54 which carries a distally pointing hollow spike member 52 as well as a proximally pointing hollow spike member 53. In the depicted state of the mixing device 1 the hollow spike member 53 is arranged just distally of the penetrable section 61 of the syringe stopper 60 and the hollow spike member 52 is arranged just proximally of the penetrable section 24 of the vial stopper 23. The syringe 10 and the vial 20 are therefore fluidly unconnected at this point. The syringe stopper 60 has at its distal end portion a circumferential sealing lip 62 which is adapted to sealingly engage with an interior portion of the sleeve body 51 to provide a fluid tight compartment 56 for the hollow spike member 53. Similarly, the tower 25 with the sealing rim 26 provides a fluid tight compartment 57 for the hollow spike member 52. This particular construction thus enables the incorporation of a sterilised sub-assembly comprising the syringe stopper 60, the connector piece 50 and the vial stopper 23 during assembly of the mixing device 1, and further ensures that sterility of the respective hollow spike members 52, 53 is maintained throughout storage, transportation and use of the mixing device 1 with no need for additional sterile barriers.

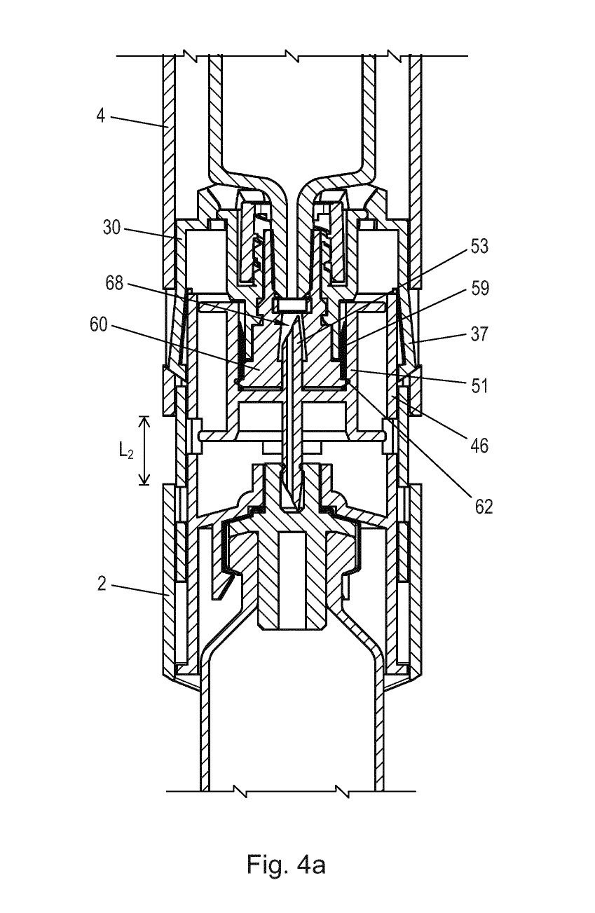

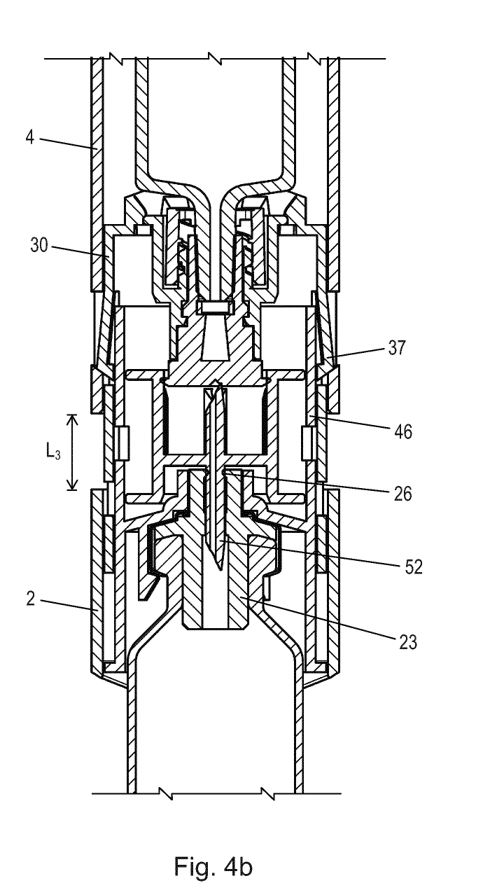

In order to enable removal of the cap 4 from the cap receiving portion 36 the cap 4 initially needs to be pressed towards the vial protector 2. The needed relative converging motion of the cap 4 and the vial protector 2 will cause relative converging motion between the syringe stopper 60 and the connector piece 50 as well as between the connector piece 50 and the vial stopper 23, as will be clear from the below. The exact sequence of motion of the syringe stopper 60 relative to the connector piece 50 and of the connector piece 50 relative to the vial stopper 23 depends on the frictional characteristics of the internal components of the mixing device 1 and the specific arrangement of these components. The sequence may be known, as dimensioned by the manufacturer, or arbitrary. FIGS. 4a and 4b illustrate the two extremes where complete converging relative motion between the syringe stopper 60 and the connector piece 50 takes place before any relative motion is induced between the connector piece 50 and the vial stopper 23 (FIG. 4a) and where complete converging relative motion between the connector piece 50 and the vial stopper 23 takes place before any relative motion is induced between the syringe stopper 60 and the connector piece 50 (FIG. 4b).

FIG. 4a is a close-up longitudinal section view of the same portion of the mixing device 1 as was depicted in FIG. 3. However, in FIG. 4a the cap 4 has been pressed downwards towards the vial protector 2, slaving the syringe 10 via the interaction between the contact faces 7 and the collar 17. The syringe 10 has been accompanied by the syringe holder 30 due to the above described fixed relationship between the Luer collar 13, the stopper fastener 70 and the syringe holder 30. Since the sleeve member 40 is unable to move axially with respect to the vial protector 2 the downward movement of the syringe holder 30 has caused the flexible arms 37 to slide axially along the wall 46. The axial distance between the distal end face of the cap 4 and the proximal end face of the vial protector 2 is now L₂, i.e. the cap 4, and thereby the flexible arms 37, has travelled the distance x₁=L₁−L₂ towards the vial protector 2.

In the illustrated situation the converging relative motion between the cap 4 and the vial protector 2 has caused the syringe stopper 60 to travel the same axial distance towards the spike base 54, whereby the spike member 53 has penetrated the penetrable section 61 and entered an interior space 68 between the penetrable section 61 and the Luer 12. During the travel of the syringe stopper 60 the circumferential sealing lip 62 has slid along the inner wall of the sleeve body 51. To avoid a resulting pressure build up in the compartment 56 one or more vents 59 are provided in the sleeve body 51, allowing gas, e.g. air, entrapped therewithin to escape. As can be seen no fluid communication between the syringe interior 18 and the vial interior 28 has yet been established and the flexible arms 37 still abut the sleeve member 40, which means that the cap 4 is still retained on the cap receiving portion 36.

Further movement of the cap 4 and the syringe 30 towards the vial protector 2 will cause relative motion between the connector piece 50 and the vial stopper 23, whereby the penetrable section 24 will be penetrated by the spike member 52.

FIG. 4b is a close-up longitudinal section view of the same portion of the mixing device 1 as was depicted in FIG. 3. However, just as in FIG. 4a, the cap 4 has been pressed downwards towards the vial protector 2, slaving the syringe 10 via the interaction between the contact faces 7 and the collar 17. The syringe 10 has been accompanied by the syringe holder 30 due to the fixed relationship between the Luer collar 13, the stopper fastener 70 and the syringe holder 30. Again, since the sleeve member 40 is unable to move axially with respect to the vial protector 2 the downward movement of the syringe holder 30 has caused the flexible arms 37 to slide axially along the wall 46. The axial distance between the distal end face of the cap 4 and the proximal end face of the vial protector 2 is in this situation L₃, i.e. the cap 4, and thereby the flexible arms 37, has travelled the distance x₂=L₁−L₃ towards the vial protector 2.

In the illustrated situation the converging relative motion between the cap 4 and the vial protector 2 has caused the connector piece 50 to travel the same axial distance towards the vial stopper 23, whereby the spike member 52 has penetrated the penetrable section 24 and entered the vial 20. As can be seen no fluid communication between the syringe interior 18 and the vial interior 28 has yet been established and the flexible arms 37 still abut the sleeve member 40, which means that the cap 4 is still retained on the cap receiving portion 36.

Further movement of the cap 4 and the syringe 30 towards the vial protector 2 will cause relative motion between the syringe stopper 60 and the connector piece 50, whereby the penetrable section 61 will be penetrated by the spike member 53.

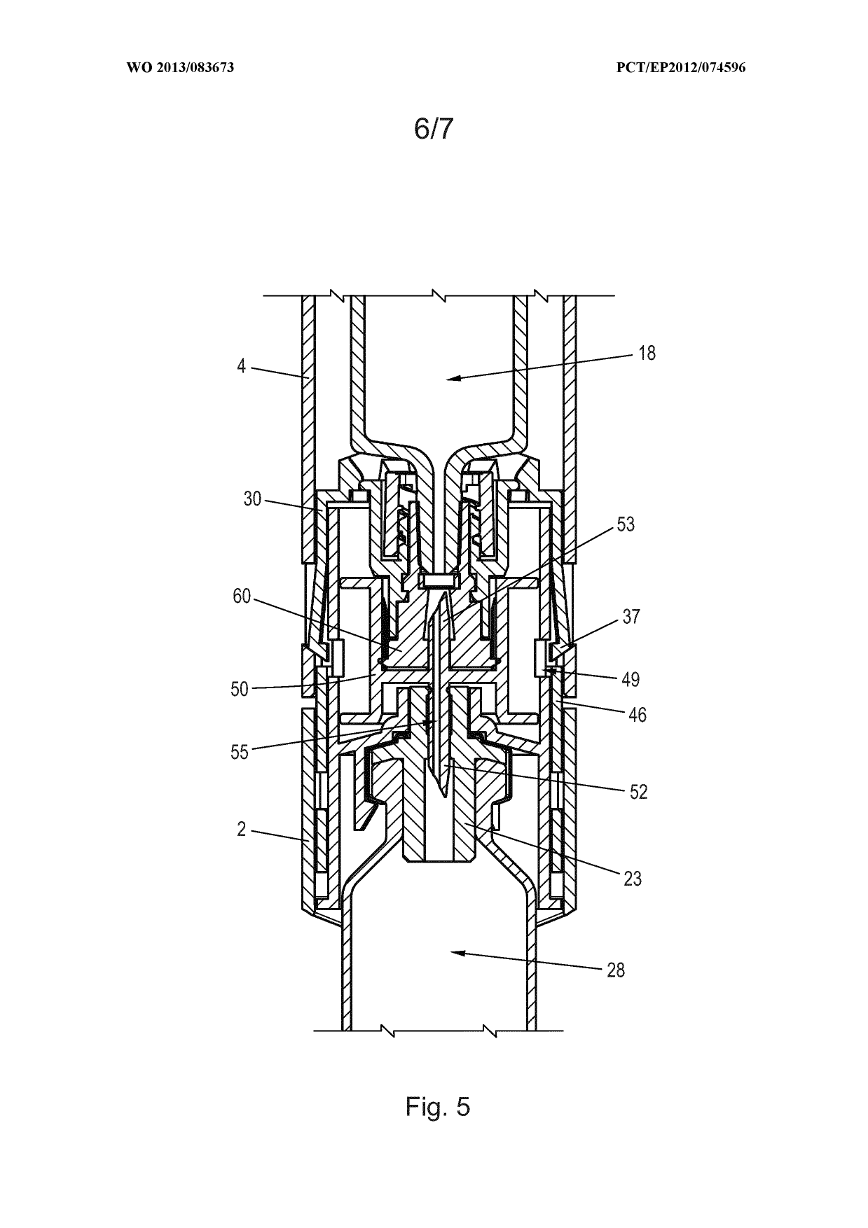

FIG. 5 is a close-up longitudinal section view of the same portion of the mixing device 1 as was depicted in FIG. 3. In FIG. 5 the cap 4 has been pressed towards the vial protector 2 a distance corresponding to complete converging motion between the syringe stopper 60 and the connector piece 50 and between the connector piece 50 and the vial stopper 23. Thereby, the spike member 52 has properly penetrated the penetrable section 24 of the vial stopper 23 and the spike member 53 has properly penetrated the penetrable section 61 of the syringe stopper 60, establishing fluid communication between the syringe interior 18 and the vial interior 28 via a lumen 55 extending through the spike members 52, 53 and the spike base 54.

In this state of the mixing device 1 the tips of the flexible arms 37 are aligned with the respective openings 49 in the sleeve member 40. A subsequent upwards directed force applied to the cap 4 will therefore cause the flexible arms 37 to deflect out of engagement with the inclined surfaces of the openings 9 and into the openings 49, allowing the cap 4 to be pulled off. Hence, a design is provided which ensures that the cap 4 is only dismountable from the cap receiving portion 36 once a proper fluid connection is established between the syringe 10 and the vial 20.

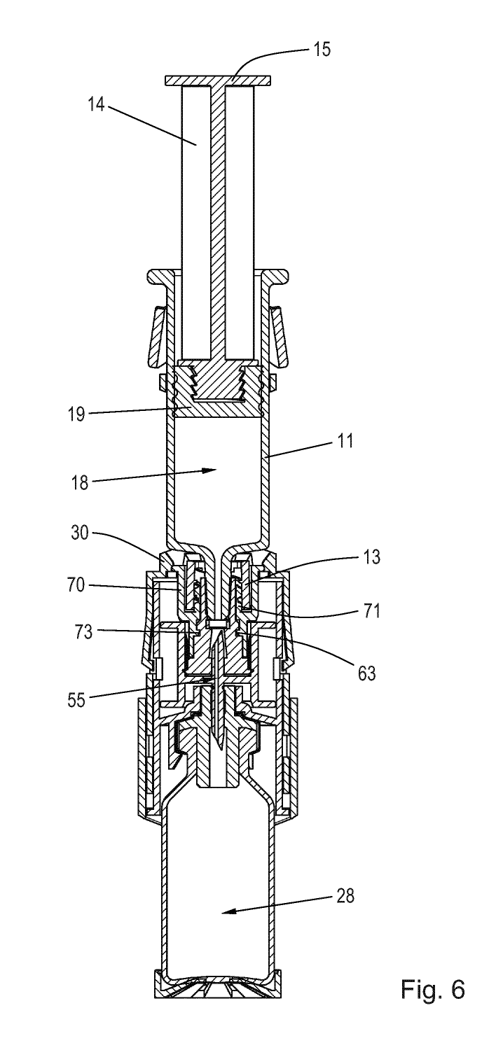

FIG. 6 shows the mixing device 1 after removal of the cap 4. In this state of the mixing device 1 the piston rod 14 is exposed and is now operable by the user, e.g. via the push face 15.

Operation of the Mixing Device

In the following a situation of use of the mixing device 1 will be described. To enable reconstitution of the powdered drug the user grips the mixing device 1 and peels off the spacer element 90 by pulling the pull ring 92. This removes the axial support for the connector piece 50 as well as the barrier for axial movement of the cap 4. After having removed the spacer element 90 the user holds the vial protector 2 in one hand and the cap 4 in the other and then moves the two hands towards each other to bring together the distal end face of the cap 4 and the proximal end face of the vial protector 2. Alternatively, the user places the vial protector 2 on an even surface, such as e.g. a table, and, using only one hand, presses the cap 4 towards the vial protector 2.

As the cap 4 moves towards the vial protector 2 the respective contact faces 7 exert a driving force on the collar 17, thereby causing the syringe 10 to move towards the vial 20. The syringe 10 pushes the stopper fastener 70 in the same direction and the stopper fastener 70 slaves the syringe holder 30 which causes the flexible arms 37 to slide along the wall 46, while the syringe stopper 60 and the vial stopper 23 converge. The initial position of the syringe holder 30 relative to the sleeve member 40 as well as the axial placement of the openings 49 in the wall 46 are such that when the current clearance, L_{C}, between the distal end face of the cap 4 and the proximal end face of the vial protector 2 satisfies L_{C}=L₁−(x₁+x₂) the tips of the flexible arms 37 are aligned with the openings 49. At this relative position of the syringe holder 30 and the sleeve member 40 the cap 4 is dismountable from the cap receiving portion 36 because an axial retraction of the cap 4 from the vial protector 2 will cause the inclined surfaces of the openings 9 to force the flexible arms 37 radially inwards into the openings 49.

Also, at this relative position of the syringe holder 30 and the sleeve member 40 the spike members 52, 53 have properly penetrated the respective penetrable sections 24, 61 to establish fluid communication between the syringe interior 18 and the vial interior 28.

The cap 4 is now pulled away from the vial protector 2, whereby the piston rod 14 becomes exposed for user operation. At this point the user holds the mixing device 1 such that the syringe 10 faces upwards. By depression of the piston rod 14 the piston 19 is advanced in the barrel 11 to force the solvent out through the Luer 12, further through the lumen 55 and into the vial 20, where it mixes with the powdered drug. The mixing device 1 is then turned up-side down and the piston rod 14 is gradually released to allow the built up pressure in the vial 20 to cause or assist a transfer of the mixed product out of the vial 20, through the lumen 55 and into the syringe 10. Alternatively, or additionally, the piston rod 14 is pulled backwards in the barrel 11 to cause or assist the transfer of the mixed product from the vial 20.

Once the mixed product is fully contained within the syringe 10, the syringe 10 is removed from the remaining parts of the mixing device 1. This is done by gripping the syringe holder 30 with one hand and the collar 17 with the other hand and then rotating the syringe 10 relative to the syringe holder 30. Because of the locking engagement between the protrusions 72 and the indentations 33 when the syringe 10 is rotated relative to the syringe holder 30 the Luer collar 13 is screwed out of engagement with the threaded inner portion 71. A circumferential groove 63 in the syringe stopper 60 is engaged by a mating ridge 73 on the stopper fastener 70 to lock the syringe stopper 60 against axial movement relative to the stopper fastener 70. Thereby, when the Luer collar 13 is released from the threaded inner portion 71 the syringe 10 can be easily removed from the stopper fastener 70, leaving the syringe stopper 60 in the remaining part of the mixing device 1. Thus, the syringe 10 is ready for connection with e.g. a cannula or a catheter immediately upon removal from the arrangement, without the user having to manually detach the syringe stopper 60 from the Luer 12 first. This reduces the number of manual steps to be performed even further.

1. A medical device comprising:
a base member,
a container comprising a container interior adapted to accommodate a first substance, and a container closure for fluidly sealing the container interior,
a variable volume reservoir comprising a reservoir interior adapted to accommodate a second substance, and a reservoir closure for fluidly sealing the reservoir interior
fluid connection structure establishing fluid communication between the container interior and the reservoir interior,
a cover removably mounted on a cover receiving portion to shield at least a portion of the variable volume reservoir, the cover being operatively coupled with the fluid connection structure to cause a relative motion between the fluid connection structure and at least one of the container closure and the reservoir closure in response to a relative motion between the cover and the base member, and
a cover engagement mechanism configured to prevent movement of the cover in a dismounting direction relative to the cover receiving portion when the cover and the base member are in a first relative position in which the container interior and the reservoir interior are fluidly unconnected and to allow movement of the cover in a dismounting direction relative to the cover receiving portion when the cover and the base member are in a second relative position in which fluid communication is established between the container interior and the reservoir interior.

2. A medical device according to claim 1, wherein the container and the variable volume reservoir are co-axially arranged, and wherein the fluid connection structure is arranged at least partially between the container and the variable volume reservoir.

3. A medical device according to claim 1, wherein the variable volume reservoir comprises a user operable actuator operatively coupled with a movable wall to selectively decrease and increase the volume of the reservoir interior, and wherein the actuator is shielded by the cover.

4. A medical device according to claim 1, further comprising a blocking element movable with respect to the base member from a first position in which relative motion between the cover and the base member from the first relative position to the second relative position is prevented to a second position in which relative motion between the cover and the base member from the first relative position to the second relative position is allowed.

5. A medical device according to claim 4, wherein the blocking element, when positioned in the first position, prevents axially converging relative motion between the cover and the base member.

6. A medical device according to claim 4, wherein the blocking element comprises a radially inwardly extending flange, which flange supports the fluid connection structure when the blocking element is positioned in the first position.

7. A medical device according to claim 1, wherein the cover is structured for mechanical interaction with a portion of the variable volume reservoir which is immovable relative to a reservoir outlet portion.

8. A medical device according to claim 1, wherein the cover comprises a rib member structured to interface with a radially outwardly extending flange on the variable volume reservoir to thereby ensure a joint motion of the cover and the variable volume reservoir in at least a first direction.

9. A medical device according to claim 1, wherein the cover engagement mechanism comprises a radially deflectable portion of the cover receiving portion arranged in releasable engagement with the cover.

10. A medical device according to claim 9, wherein the radially deflectable portion comprises an inclined contact surface structured to interact with an inclined portion of the cover, and wherein the inclined contact surface and the inclined portion of the cover are structured to exert a radially inwards directed force to the radially deflectable portion in response to a dismounting axial force being applied to the cover.

11. A medical device according to claim 9, wherein the cover engagement mechanism further comprises an axially extending wall structured for sliding abutment with the radially deflectable portion to prevent radial inwards deflection of the radially deflectable portion when the cover and the base member are in the first relative position or between the first relative position and the second relative position, and an opening in the axially extending wall adapted to allow radial inwards deflection of the radially deflectable portion when the cover and the base member are in the second relative position.

12. A medical device according to claim 11, wherein the axially extending wall forms part of a sleeve member which is structured to accommodate at least a portion of the fluid connection structure and to allow axial movement of the fluid connection structure in its interior.

13. A medical device according to claim 12, wherein the sleeve member comprises container engagement structure structured to axially fix the container relative to the axially extending wall.

14. A medical device according to claim 1, wherein the base member surrounds and supports at least a portion of the container.

15. A medical device according to claim 1, wherein the variable volume reservoir is releasably fixed to a reservoir holder, which reservoir holder comprises the cover receiving portion.
